(19) United States
(12) Patent Application Publication
(10) Pub. No.: US 2013/0048479 A1
(43) Pub. Date: Feb. 28, 2013

(54) Method and Apparatus for Switching Off a Switch

(71) Applicants: Martin Paulus, Oberderdingen (DE); Mathias Schmidt, Sternenfels (DE)

(72) Inventors: Martin Paulus, Oberderdingen (DE); Mathias Schmidt, Sternenfels (DE)

(73) Assignee: E.G.O. Elektro-Geratebau GmbH, Oberderdingen (DE)

(21) Appl. No.: 13/579,818

(22) PCT Filed: Jan. 19, 2011
(86) PCT No.: PCT/EP2011/050688

§ 371 Date: Oct. 23, 2012

(30) Foreign Application Priority Data
Feb. 17, 2010 (DE) 10 2010 008 755.6

(51) Int. Cl. H01H 57/00

(52) U.S. Cl. 200/181

(57) ABSTRACT

Apparatus and methods provide for the application of a mechanical impulse to the switch at a phase angle before a zero crossing of the current to disconnect a switching contact and mating contact to control electric arcing. According to one aspect, a next zero crossing of an alternating current is detected, and in response, a mechanical impulse with a phase angle of between 5° and 20° is applied before the next zero crossing of the alternating current. The mechanical impulse disconnects the switching contact from the mating contact of the switch.

### PRIORITY CLAIM

This application is the National Stage of, and claims priority to, PCT patent application PCT/EP2011/050688 filed Jan. 19, 2011, which claims the priority of German patent application DE 10 2010 008 755.6 filed Feb. 17, 2010.

### TECHNICAL FIELD

The invention relates to a method for switching off a switch or for disconnecting a switching contact from a mating contact, and to a corresponding apparatus, wherein preferably switching off free of an electric arc can be achieved thereby.

### BACKGROUND

When switching off switches or disconnecting a switching contact from a mating contact it is often a problem that, when current is still flowing, in particular including when alternating current is flowing, an electric arc can be produced which can delay the disconnection of the contacts and also damages the contacts. Particularly in the case of alternating current, for example at 50 Hz, when the contacts are disconnected, an electric arc, as a result of the small gap between the contacts, can always remain until the next zero crossing of the current. This can have a maximum duration of almost 10 ms. Although it is possible in theory to switch off the switch or disconnect the contacts very rapidly in a force-actuated manner, in practice this is still not accomplished rapidly enough: an electric arc still occurs.

### SUMMARY

It should be appreciated that this Summary is provided to introduce a selection of concepts in a simplified form that are further described below in the Detailed Description. This Summary is not intended to be used to limit the scope of the claimed subject matter.

This disclosure addresses the problems discussed above by providing a reliable and low-wear method for switching, and a corresponding switch, that utilizes the application of a mechanical impulse to the switch at a phase angle before a zero crossing of the current to disconnect a switching contact and mating contact to control electric arcing. According to one aspect, a method for switching off a switch includes detecting a next zero crossing of an alternating current, and in response, applying a mechanical impulse with a phase angle of between 5° and 20° before the next zero crossing of the alternating current. The mechanical impulse disconnects the switching contact from the mating contact of the switch.

According to another aspect, a switch includes a switching contact, a mating contact, and an actuator. The switching contact and the mating contact are moveable with respect to one another. The actuator is configured to generate an impulse with an impulse direction along a direction of disconnection of the two contacts. The actuator may act on the mating contact, the switching contact, or on a switching drive carrying the switching contact.

These and further features emerge not only from the claims but also from the description and from the drawings, wherein the individual features can be realized, and can constitute embodiments which are advantageous and which are protectable per se and for which protection is claimed here, in each case on their own or as a plurality in the form of subcombinations in an embodiment of the invention and in other fields. The subdivision of the application into individual sections and subheadings does not restrict the statements made under them in terms of their general validity.

### BRIEF DESCRIPTION OF THE DRAWINGS

Exemplary embodiments of the invention are schematically illustrated in the drawings and are explained in more detail below. In the drawings:

FIG. 1 shows a schematic illustration of an apparatus according to the disclosure herein having a combined actuator and sensor on the mating contact of a switch, and

FIG. 2 shows an illustration of the temporal profile of the current and contact force and switching off with and without the disclosure herein.

### DETAILED DESCRIPTION

As discussed above, conventional switches often create an undesirable electric arc between switch contacts when the switch is opened or “switched off” One conventional switch is disclosed in DE 102006057260 A1. In this case a type of catch spring is intended to implement rapid switching when a trigger point is overshot. Nevertheless, even here it is not possible to avoid the production of on average an above-described electric arc having a duration of a few milliseconds.

DE 1096453 discloses, for a similar switch, superposing a low additional force, which is constantly pulsating and in phase with the current, on the force acting on the switching contact and mating contact. In this way, the switch can be switched off approximately around the zero crossing of the current. However, the force must still be constantly applied.

DE 1113745 discloses a similar switch. That document explicitly discloses vibrations that are intended to help to prevent sticking or welding of the switching contact and mating contact.

Methods and apparatus disclosed herein address the problems discussed above, providing a reliable and low-wear method for switching and corresponding switch. Advantageous and preferred embodiments of the invention are the subject matter of the further claims and are discussed in more detail below. Some of the features below are described only for the method or only for the apparatus. However, irrespective of this they are intended to be applicable both to the method and to the apparatus. The wording of the claims is incorporated by express reference in the content of the description.

As discussed below with respect to the various embodiments, it is provided that the switch switches alternating current, advantageously at a frequency of 50/60 Hz at 100 to 400 volts and current up to approximately 16 A, that is to say in the domestic or industrial range. According to various embodiments, a mechanical impulse may applied to the switch or a contact with an angle or phase angle of between 5° and 20°, advantageously between 10° and 18°, particularly advantageously approximately 13°, before a zero crossing of the current. In particular, this impulse may have an impulse direction for disconnecting the switching contact and mating contact, or the impulse may travel in the direction of disconnection of the switching contact and mating contact. An easier disconnection of switching contact and mating contact can be achieved not only generally thereby. An impulse on the switch for the disconnection of switching contact and mating contact at a phase angle as described above may lead to independent switching off exactly at the zero crossing of the load current. The mechanical inertia of the switch or the total delay in the system may result in the contacts being disconnected by a corresponding impulse shortly before the zero crossing of the current in the case of a sufficiently low contact force, as occurs when the contact is switched off as expected.

If the present contact force that presses the switching contact and mating contact together is still sufficient or very high, then the short impulse may not accomplish anything and the contacts will remain connected. The contacts are disconnected at the next zero crossing of the current only when a defined contact-force threshold is undershot and the impulse is triggered with the specified phase angle. A particularly advantageous phase angle found in the context of the disclosure may be approximately 13°. In more sluggish systems, the angle can be somewhat larger; in faster-acting systems or systems which are less sluggish, the angle can also be smaller, for example closer to said 5° or even said 10°. It may be important to determine the correct phase angle because the time window for triggering the impulse at the correct time is only approximately 100 μs.

In a first simple embodiment, it can be provided that a corresponding short impulse is applied to the switch or to a contact with the specified phase angle before each zero crossing. If the contacts are then to be switched or disconnected, they are disconnected from one another at that instant when the contact force indeed becomes very low, or upon the next half-cycle, and the switch is opened. This opening then occurs exactly at the zero crossing of the current, and thus without an electric arc, with the phase angle correspondingly coordinated with the system. This is a simple embodiment in which the expenditure relating to construction and measurement is limited. It may in return be accepted that the impulse be triggered very often or, when the switch is in the closed state, upon every half-cycle. As a result, an electric arc may be generated during operation from time to time. Nevertheless, wear is lowered, such as to approximately 10%, of what is usual without the concepts described according to this embodiment.

The method can be improved or made even more exact in an alternative embodiment in which the contact force is additionally also measured, advantageously continuously detected. In particular, it can then be provided that such an impulse need not be triggered or applied to the switch continuously or too often, rather only when the contact force undershoots a defined contact-force threshold. In particular, such undershooting is a reliable indication that very soon the switch is to switch or is to disconnect the switching contact from the mating contact. In this way it is possible to provide for example that the contact-force threshold is between 0.01 N and 0.03 N, advantageously is approximately 0.02 N. It is then usually assumed that the contact force then decreases further and the impulse is triggered at the next aforementioned phase angle between 5° and 20°, or between 10° and 18°, before a zero crossing of the current, so that the switching contact and mating contact are then disconnected from one another exactly at the next zero crossing.

Advantageously, the phase angle is also detected continuously, particularly advantageously with a current detection known per se. The current detection or the orientation of the switching instant on the current profile has an advantage compared to the voltage profile in that, particularly when switching inductive loads with a phase shift, fewer problems occur or fewer sparks or electric arcs are produced. The current detection is even more accurate here. As the usually thermal drive of such a switch is relatively slow, there is a sufficient period of a plurality of half-cycles to switch when the contact force has fallen below a certain value from which the impulse leads to correct switching until that instant when the contact force becomes zero without the provision of the disclosure herein, or when the switch would switch in a normal manner and in this way an electric arc would possibly be produced.

It is possible to take particular account of the characteristics of the electric arc if switching is always carried out in such a way that the more robust or denser or heavier contact is anodic or positive with respect to the other contact. Usually, this is the mating contact since it is also arranged on a thicker carrier that dissipates heat better. This makes it possible to take account of the fact that, if an electric arc is possibly nevertheless produced, the temperature and therefore the damage is greater at the anodic contact. The generated heat can be better transported away from this denser contact. Usually, in the case of a snap-action switch as mentioned at the outset, both contacts bear against one another with a force of from approximately 0.4 N to 0.6 N.

In one advantageous embodiment of the disclosure, the impulse is relatively short and can have a duration of a few milliseconds, for example at least 2 ms to 4 ms, advantageously 3 ms. Longer impulses may not have any advantages, however nor may they have any negative effect.

A deflection of said impulse can likewise be in the range of a few micrometers, advantageously approximately 15 μm to 50 μm. Particularly advantageously, an impulse may have a deflection of somewhat 30 μm. The impulse force to be applied can be extremely small, advantageously less than 0.5 N, and this fits in with an MEMS use.

An MEMS system which can be used in an embodiment of the disclosure can also have an associated switching logic which is adaptive or capable of learning, as it were. In this way, it can be detected whether the disconnection of the contacts will actually take place without an electric arc at a phase angle once set. If changes or shifts arise here in the switch system or in the overall system, the phase angle can be readjusted in order to make it possible to avoid the production of electric arcs. Furthermore it can even be provided here that the deliberate production of an electric arc is programmed in such a controller, although at large, but recurring, intervals. In particular, this has the advantage that surfaces of the contacts, which would otherwise be oxidized over time, are cleaned with the result that a positive effect can arise therefrom. In this case, however, a frequency of one electric arc after 500 to 1000 switching operations is expected to be sufficient.

An aforesaid MEMS component can advantageously contain all the functions, that is to say a piezo element which is both an actuator for the impulse and also a sensor for measuring the contact force. Similarly, a switching logic can be included. Power may easily be able to be supplied through an additional contact.

According to one embodiment of the disclosure, it is possible for the impulse to act on a switching drive, preferably a switching arm, carrying the switching contact, possibly also to act on the switching contact itself In this way, the disconnection of switching contact and mating contact can be directly supported.

In an alternative embodiment, the impulse can be applied to the mating contact or to a device carrying the mating contact, at least provided that this is not formed in a way that is too solid or heavy or stiff in comparison to the rest of the switching. In an advantageous embodiment, it is possible here for an actuator which generates the impulse to bear directly against the mating contact. In one embodiment of the disclosure, such an actuator can even carry the mating contact or form the fixing base therefor.

Advantageously, the disclosed concepts may be used for a thermally driven switch or a switch which is triggered by means of thermal expansion elements such as bimetal elements or the like, as are described, for example, in DE 102006057260 A1 mentioned at the outset. Advantageously, the actuator used can be a magnetic, thermal or piezo actuator. In the interests of simplicity and due to their robustness, piezo actuators are preferred.

In a further embodiment of the disclosure in accordance with the second alternative mentioned above, an actuator can at the same time be used to measure the contact force between the switching contact and mating contact, in particular with MEMS use. Particularly good for this purpose is an aforementioned piezo actuator, the use of which lowers both construction and control expenditure. An MEMS chip could contain the complete sensor system and actuator as well as the evaluation and control system therefor, including optionally adaptive control electronics.

The concepts disclosed herein can be used in general in switches, particularly advantageously on the one hand in switches having catch springs which are able to be triggered thermally or using bimetals, for example according to U.S. Pat. No. 7,345,572 B2, and on the other hand also in relays, in particular magnetic relays. Switching operations can also be improved there.

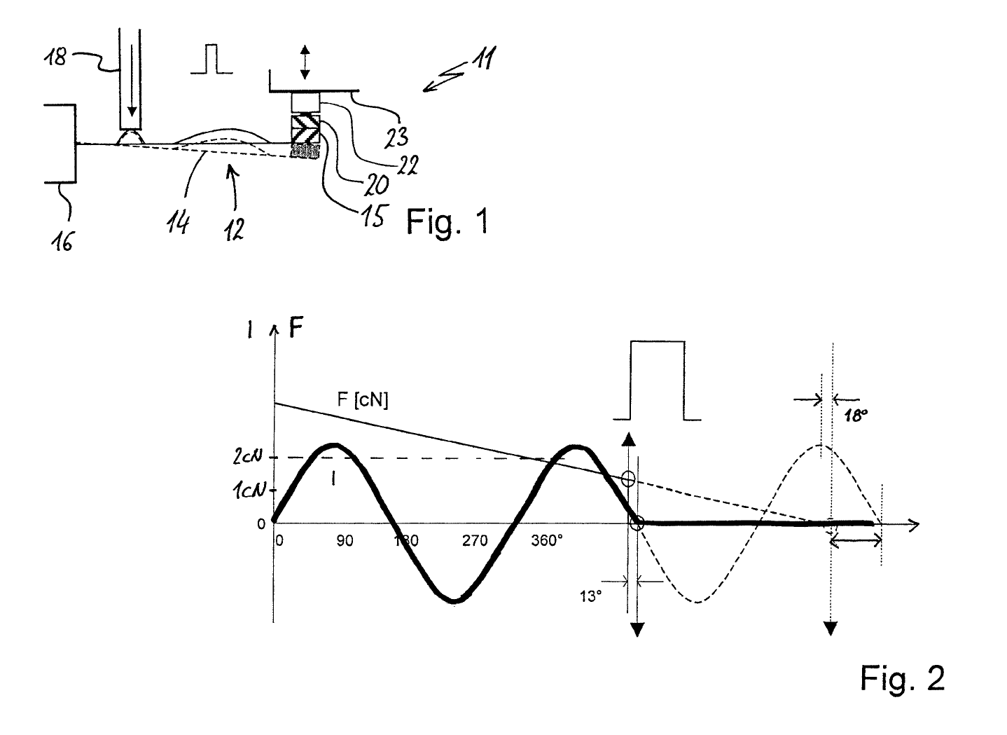

In the following detailed description, references are made to the accompanying drawings that form a part hereof, and which are shown by way of illustration, specific embodiments, or examples. Referring now to the drawings, in which like numerals represent like elements through the several figures, the switching method and corresponding switch will be described. Turning to FIG. 1, the illustrated switching apparatus 11 or the switch 12 has a switching contact 15 on a switching arm 14. This switching arm 14 is firmly mounted on the left on a switching-arm base 16. It can, however, be formed from a trigger 18 which is, for example, a rod of a rod thermostat as is known from U.S. Pat. No. 7,345,572 B2, for example. Alternatively it can be the trigger of a magnetic relay, a piezo component or an MEMS. It can be seen that the trigger 18 presses downward onto the switching arm 14 for the purpose of triggering the switching/disconnection process.

In the closed position of the switch 12, the switching contact 15, with the switching arm 14 situated at the top, bears against a mating contact 20. Consequently, current can flow through the contact pair. The mating contact 20 is mounted or fastened on a piezo element 22 which in turn is arranged on a mating contact base 23. The piezo element 22 forms the force sensor, mentioned at the outset, for detecting the contact force. Furthermore, at the same time it also forms the actuator which applies a mechanical impulse to the switch 12. For this purpose, the piezo element 22 is briefly triggered. Since it is fixed in this direction on account of its mounting on the robust mating contact base 23, its impulse is delivered to the mating contact supported thereon and thus in turn to the emplaced switching contact 15 on the switching arm 14.

The switching behavior is described with reference to FIG. 2. The current, which has a sinusoidal profile, is illustrated there against the phase angle. At a basic frequency of 50 Hz, a full cycle or the phase angle thereof of 360° corresponds to a period of 20 ms.

Furthermore, the contact force, with which the switching contact 15 bears against the mating contact 20, is illustrated in FIG. 2. In the example shown, the force decreases; advantageously however this decrease does not necessarily have to be linear. It can be seen from the dashed line that the contact force will become zero or less than zero at some point and then usually the switching arm 14, which is in the form of the catch spring mentioned at the outset, moves so as to disconnect the switching contact 15 from the mating contact 20. However, since current is still flowing here or is a distance away from its next zero crossing, an electric arc with a duration of several milliseconds is, or would be, produced.

As has been described, the phase angle of the current is continuously detected with a current detection not shown in FIG. 1. In a similar manner, the contact force between switching contact 15 and mating contact 20 is measured using the piezo element 22. In the illustrated example, this contact force has reached approximately 0.02 N when the phase angle is overall approximately 420°, that is to say long before the next zero crossing. If the instant when the current has a phase angle of approximately 13° before the next zero crossing is then detected, then the contact force has once again fallen here somewhat to below 0.02 N. A controller, not shown, can identify both conditions as being fulfilled and causes the piezo element 22, which is an actuator, to deliver a short impulse. As indicated in FIG. 1, this impulse is directed such that it causes the switching contact 15 on the switching arm 14 to disconnect the contacts or to open the switch 12. This then takes place with a certain inertia or delay, above all due to the mechanical inertia, after a very short time or even exactly so that the contacts are disconnected at the zero crossing of the current. Consequently no interfering electric arc occurs.

Otherwise, as can be seen from the dashed profiles, if the contact force went all the way to zero, switching would occur at an instant when the current would be near its maximum. In this case an electric arc with a duration of approximately 4 ms would be produced which would have the damaging consequences mentioned at the outset.

The piezo element 22, which is an actuator, can generate an impulse having a deflection, mentioned at the outset, of approximately 30 μm, and force of slightly less than 0.5 N. The impulse duration is for example 3 ms.

The subject matter described above is provided by way of illustration only and should not be construed as limiting. Various modifications and changes may be made to the subject matter described herein without following the example embodiments and applications illustrated and described, and without departing from the true spirit and scope of the present disclosure, which is set forth in the following claims.

1. A method for switching off a switch, comprising:
detecting a next zero crossing of an alternating current;
in response to detecting the next zero crossing, applying a mechanical impulse with a phase angle of between 5° and 20° before said next zero crossing of said alternating current, the mechanical impulse operative to disconnect a switching contact from a mating contact of said switch.

2. The method of claim 1, wherein said mechanical impulse has a direction for disconnecting said switching contact and said mating contact.

3. The method of claim 1, wherein said phase angle is from approximately 10° to 18°.

4. The method of claim 3, wherein said phase angle is approximately 13°.

5. The method of claim 1, wherein, without measuring a contact force between said switching contact and said mating contact, said mechanical impulse is applied to said switch with said phase angle of between 5° and 20° before said next zero crossing of said alternating current.

6. The method of claim 1, further comprising:
continuously measuring a contact force between said switching contact and said mating contact; and
triggering said mechanical impulse when a threshold for said contact force between said switching contact and said mating contact from approximately 0.01 N to 0.03 N is undershot and said phase angle is between 5° and 20°.

7. The method of claim 1, wherein said mechanical impulse is only ever applied to said switch upon every second half-cycle of said alternating current with said phase angle of between 5° and 20° before said next zero crossing of said alternating current.

8. The method of claim 7, wherein said mechanical impulse is applied to said switch where said mating contact or said switching contact which is not moved during a disconnection of said contacts is anodic with respect to a cathodic other contact.

9. The method of claim 1, wherein said mechanical impulse has a duration of less than 3 milliseconds.

10. The method of claim 1, wherein said mechanical impulse has a duration of approximately 3 ms.

11. The method of claim 1, wherein said mechanical impulse has a deflection of from approximately 15 μm to 50 μm.

12. The method of claim 11, wherein said mechanical impulse has a deflection of approximately 30 μm.

13. The method of claim 1, wherein said mechanical impulse acts on a switching drive carrying said switching contact or acts on said switching contact itself.

14. The method of claim 1, wherein said switching drive comprises a switching arm.

15. The method of claim 1, wherein said mechanical impulse acts on said mating contact itself.

16. The method of claim 15, wherein an actuator for said mechanical impulse bears directly against said mating contact.

17. The method of claim 1, wherein said mechanical impulse is triggered by means of an actuator in a form of a magnetic, a thermal or a piezo actuator.

18. The method of claim 1, wherein said actuator is at the same time designed to measure a contact force between said switching contact and said mating contact.

19. The method of claim 1, further comprising continuously detecting said phase angle of said alternating current for accurate triggering.

20. A switch, comprising:
a switching contact;
a mating contact, wherein the switching contact and the mating contact are moveable with respect to one another;
an actuator configured to generate an impulse with an impulse direction along a direction of disconnection of said switching contact and said mating contact, said actuator acting on said mating contact or said switching contact or on a switching drive carrying said switching contact.

21. The switch of claim 20, wherein said actuator comprises a piezo actuator.

22. The switch of claim 21, wherein said piezo actuator is configured to measure a contact force between said switching contact and said mating contact.

23. The switch of claim 22, wherein said piezo actuator forms one structural unit or carries said switching contact or said mating contact.

24. The switch of claim 20, wherein said mating contact is arranged rigidly on said switch and said switching contact is carried by a switching drive or a switching arm, and wherein a trigger device abuts said switching drive.

25. The switch of claim 24, wherein said trigger device comprises a thermal trigger device.
